(19) United States
(12) Patent Application Publication
(10) Pub. No.: US 2012/0300138 A1
(43) Pub. Date: Nov. 29, 2012

(54) LIGHTING DEVICE, DISPLAY DEVICE AND TELEVISION RECEIVER

(75) Inventor: Yuya Takano, Osaka-shi (JP)

(73) Assignee: SHARP KABUSHIKI KAISHA, Osaka-shi, Osaka (JP)

(21) Appl. No.: 13/522,616

(22) PCT Filed: Dec. 13, 2010
(86) PCT No.: PCT/JP10/72332

§ 371 Date: Jul. 17, 2012

(30) Foreign Application Priority Data
Jan. 26, 2010 (JP) 2010-014253

(51) Int. Cl. G09F 13/18; H04N 5/66; G02F 1/13357; F21V 8/00; F21V 13/02

(52) U.S. Cl. 348/739; 362/613; 362/612; 362/602; 362/606; 349/62; 348/E05.133

(57) ABSTRACT

It is an object of the present invention to provide a lighting device including a plurality of light guide bodies in which brightness difference between light guide bodies is reduced. A backlight unit 12 according to the present invention includes a plurality of LEDs 17 as light sources and a plurality of light guide bodies 31 each having a light entrance surface 31a and a light exit surface 31b. The light entrance surface faces the light source and through which light emitted from the light source enters the light guide body. The light in the light guide body exits through the light exit surface. The light guide bodies 31 are collectively covered with a fixing member 32, so that a positional relationship between the light guide bodies 31 is constant. Further, the fixing member 32 has a relative refractive index of one or less with respect to the light guide body 31.

### TECHNICAL FIELD

The present invention relates to a lighting device, a display device and a television receiver.

### BACKGROUND ART

In recent years, a display element of an image display device such as a television receiver has shifted from a conventional CRT display panel to a thin display panel, such as a liquid crystal panel and a plasma display panel. This enables the image display device to have a reduced thickness. The liquid crystal panel does not emit light, and thus the liquid crystal panel requires a backlight unit as a separate lighting device. A type of a backlight unit is broadly divided into a direct type and an edge-light type depending on its structure. In order to achieve a thinner liquid crystal display device, an edge-light type backlight unit is preferably used. For example, an edge-light type backlight unit disclosed in Patent Document 1 has been known.

Patent Document 1 discloses a backlight unit including a plurality of light sources and a plurality of light guide plates. The light sources are arranged linearly on side edge portions (side edges) of the backlight unit. The light guide plates are each configured to guide the light emitted from the light sources so as to exit toward a liquid crystal panel. The light guide plates each extend in a direction perpendicular to the arrangement direction in which the light sources are arranged and are arranged along the arrangement direction of the light sources. In such a configuration in which the light guide plate is constituted by the separate light guide plates, it can be independently determined whether or not to exit light for each of the light guide plates. In other words, area-active control can be performed on each of the light guide plates. This improves contrast performance of the display screen.

Patent Document 1: Japanese Unexamined Patent Application Publication No. 2001-92370

### Problem to be Solved by the Invention

In the above configuration, the light guide plates are each independently held by a chassis, for example. Accordingly, distances from the light sources to the corresponding light guide plates may be varied due to installation error of each of the light guide plates, for example. If relative positions of light entrance surfaces of the light guide plates with respect to the corresponding light sources vary from each other, the light entrance surfaces are likely to have different light entrance efficiency. As a result, the light guide plates may have different brightness.

### DISCLOSURE OF THE PRESENT INVENTION

The present invention was accomplished in view of the foregoing circumstances. An object of the present invention is to reduce brightness difference between light guide bodies.

### Means for Solving the Problem

To solve the above problem, a lighting device according to the present invention includes a plurality of light sources, a plurality of light sources, a plurality of light guide bodies each having a light entrance surface and a light exit surface, and a fixing member configured to collectively cover the plurality of light guide bodies. The light entrance surface faces at least one of the light sources and through which light emitted from the light source enters. The light in the light guide body exits through the light exit surface. The fixing member has a relative refractive index of one or less with respect to the light guide body.

This configuration enables positional relationship of the light guide bodies to be constant, because the light guide bodies are collectively covered with the fixing member. Specifically, when the position of one of the light guide bodies with respect to the light sources is determined, positions of the other light guide bodies are automatically determined. As a result, the positional relationship of the light guide bodies with respect to the light sources can be constant, and thus the light entrance efficiency of the light emitted from the light sources to the light entrance surfaces of the light guide plates can be constant. Accordingly, brightness difference between the light guide bodies can be reduced.

In addition, the light guide bodies can be treated as one component. This eliminates assembly operations of the individual light guide bodies and facilitates an assembly operation of the lighting device.

The fixing member is made of material having a smaller refractive index than the material of the light guide body. This prevents the light from exiting from the light guide body through a surface other than the light exit surface due to the total reflection. Accordingly, the light entered the light guide body is prevented from entering the adjacent light guide body through the fixing member. Thus, unevenness brightness due to the light entering through the surface other than the light entrance surface is less likely to occur.

The following configurations may be preferably employed as embodiments according to the present invention.

(1) The light exit surface has a plan view rectangular shape having a long side and a short side. The light guide bodies are arranged such that the light exit surfaces thereof are flush with each other and the long side of each light exit surface is parallel to each other. The light guide sources are arranged to face side surfaces of the light guide bodies that extend along the short side of the light exit surfaces. As above, the lighting device is an edge-light type lighting device in which the light sources are arranged on the side surface of the light guide body. Thus, compared with the direct-type lighting device, the lighting device according to the present embodiment can be thinner.

(2) The fixing member has a refractive index substantially equal to a refractive index of air. Accordingly, the same conditions as in the case where the light guide body is fixed without the fixing member can be obtained. With this configuration, changes in the configuration around the light guide bodies of the lighting device are not required, and thus this technology can be readily applied. Note that “substantially equal” used herein means that the fixing member has the refractive index of about 1.4.

(3) The fixing member is at least provided between the adjacent light guide bodies. The fixing member provided between the adjacent light guide bodies contains a light diffusing material. With this configuration, the light exiting from the light guide bodies to the gaps between the light guide bodies is refracted and diffused by the light diffusing material. Thus, the light exiting from the light guide body is less likely to enter the adjacent light guide bodies through the gap. As a result, the uneven brightness due to the light entering a surface other than the light entrance surface is prevented.

If a member having a refraction index substantially equal to that of air is provided between the gap between the light guide bodies, the light exiting from the light guide bodies is visible as emission line. The other portions than the portion where the emission line appears are recognized as dark portions. Further, the gap and the light exit surface of the light guide body have different brightness. The brightness difference between the gaps can be reduced by providing the light diffusing material in the gap between the light guide bodies to diffuse the light entering the gap. Further, the brightness difference between the light exit surface of the light guide body and the gap between the light guide bodies can be reduced by controlling the ratio of the light diffusing material to be contained to diffuse the light entering the gap.

(4) The fixing member has a uniform thickness in a section covering the light exit surfaces of the light guide bodies. If the fixing member has an uneven thickness in the section covering the light exit surfaces of the light guide bodies, light transmission of the light exiting may be varied, and thus uneven brightness may occur. In order to prevent this, in the present embodiment, the fixing member has the uniform thickness at least in the section covering the light exit surfaces of the light guide bodies.

(5) The light entrance surfaces of the light guide bodies are not covered with the fixing member and directly exposed to the light sources. If the fixing member is provided between the light source and the light entrance surface of the light guide body, the light that has passed through the fixing member travels in a different direction compared to the case where the fixing member is not provided, because, at least, the light refractive index of the fixing member is not equal to that of air. Accordingly, the fixing member may unnecessarily change the traveling direction of the light, leading to deterioration of the light entrance efficiency. In order to prevent this, preferably, the light entrance surface of the light guide body may not be covered with the fixing member.

(6) The light guide bodies and the fixing member form one plate-like shape as a whole. With this configuration, the guide bodies can be treated in the same manner as the conventional light guide body that is formed of one plate, for example.

(7) The lighting device further includes a reflector configured to reflect the light from the light sources. The reflector is arranged on a side of the light guide body that is opposite to the light exit surface. With this configuration, the light traveling in the light guide body to the side opposite to the light exit surface is reflected by the reflector, and thus the light entering the light guide body efficiently exits from the light exit surface.

(8) The light guide bodies are collectively formed by a molding process using the fixing member. With this configuration, the light guide bodies can be readily collectively covered. Unlike the process in which the light guide bodies are connected using a plurality of fixing members, installation error do not occur in the molding process in which the light guide bodies are fixed to each other at one time. Thus, the positional relationship of the light guide bodies can be more surely constant.

(9) The light sources are LEDs. With this configuration, improved brightness, a longer service life and a lower power consumption, for example, can be achieved.

(10) The lighting device further includes an LED board on which the LEDs are mounted. The LED board extends along an arrangement direction in which the light guide bodies are arranged. This configuration facilitates arrangement of the LEDs and wiring between the LEDs.

(11) Each one of the light sources is arranged so as to correspond to each one of the light entrance surfaces of the light guide bodies. An area active control can achieve the maximum effect by such an arrangement in which the light guide body corresponds to one of the light sources, which is the smallest unit to be driven and controlled.

To solve the above problem, a display device according to the present invention includes the above lighting device and a display panel configured to provide display using light from the lighting device.

In such a display device, the lighting device that supplies light to the display panel reduces the brightness difference between the light guide plates, and thus uneven brightness is less likely to occur. This achieves display having excellent display quality.

An example of the display panel is a liquid crystal panel. Such a display device is applied to various uses such as a television or a desktop of a personal computer as a liquid crystal display device, and especially appropriate for a large-screen device.

### Advantageous Effect of the Invention

According to the present invention, the brightness difference between the light guide bodies can be reduced.

### BRIEF DESCRIPTION OF THE DRAWINGS

FIG. 1 is an exploded perspective view illustrating a general construction of a television receiver according to the first embodiment of the present invention;

FIG. 2 is an exploded perspective view illustrating a general construction of a liquid crystal display device included in the television receiver;

FIG. 3 is a cross-sectional view illustrating a cross-sectional construction of the liquid crystal display device taken along a short-side direction;

FIG. 4 is a cross-sectional view illustrating a cross-sectional construction of the liquid crystal display device taken along a long-side direction;

FIG. 5 is a plan view illustrating a planar arrangement of the LEDs and the light guide plate;

FIG. 6 is an enlarged cross-sectional view of a major part of the light guide plate according to the first modification of the first embodiment of the present invention taken along the short-side direction;

FIG. 7 is an enlarged cross-sectional view of a major part of the light guide plate according to the second embodiment of the present invention taken along the short-side direction;

FIG. 8 is a partial plan view illustrating a planar arrangement of the LEDs and the light guide plate according to the third embodiment of the present invention;

FIG. 9 is an exploded perspective view illustrating a general construction of a liquid crystal display device according to the fourth embodiment of the present invention; and

FIG. 10 is a cross-sectional view illustrating a cross-sectional construction of the liquid crystal device taken along the long-side direction.

### MODE FOR CARRYING OUT THE INVENTION

### First Embodiment

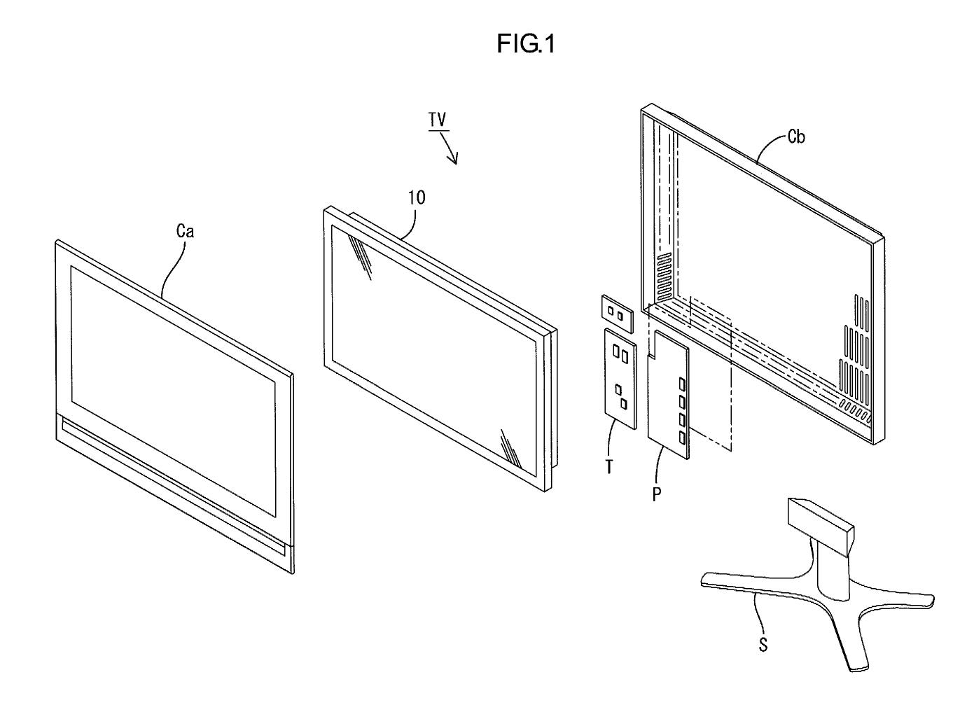

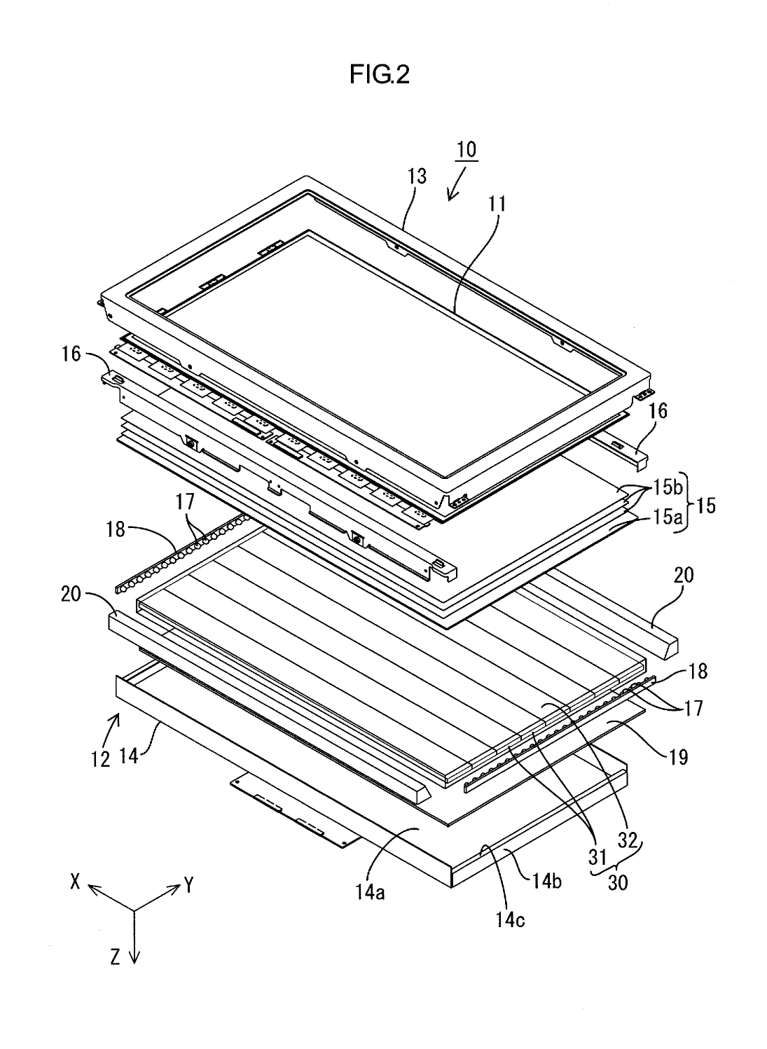

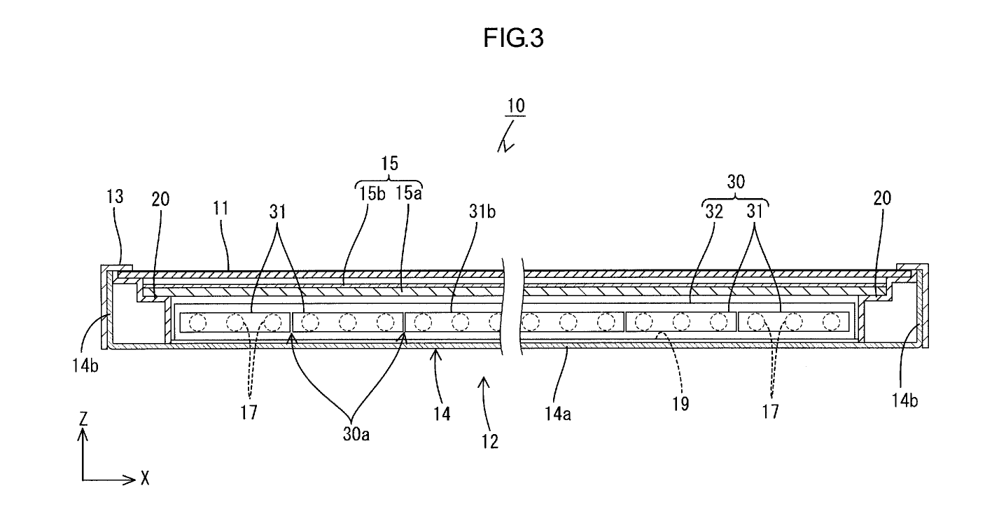

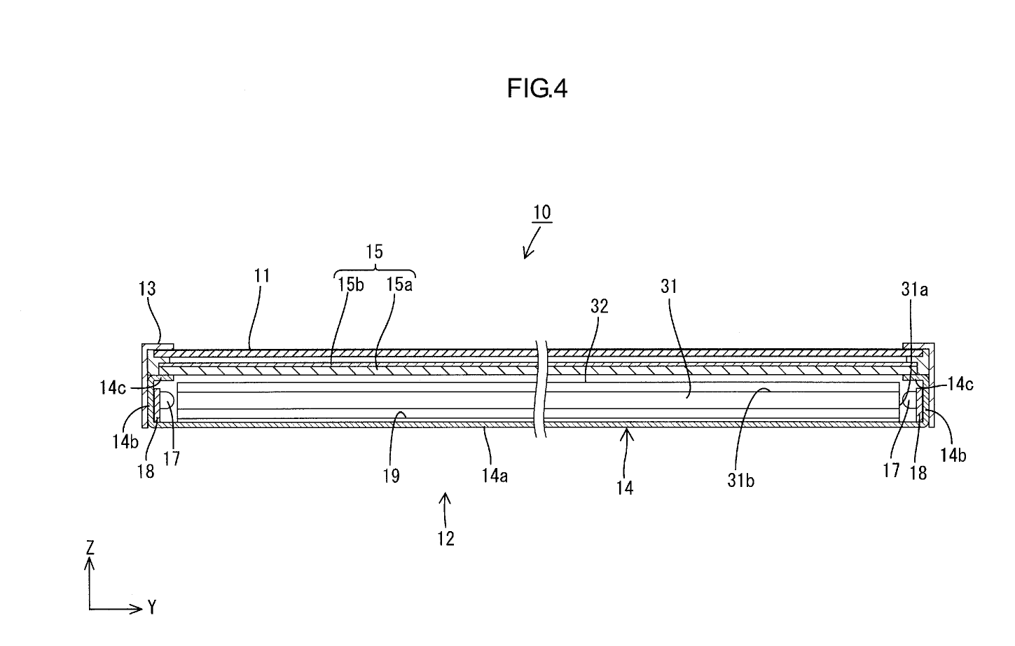

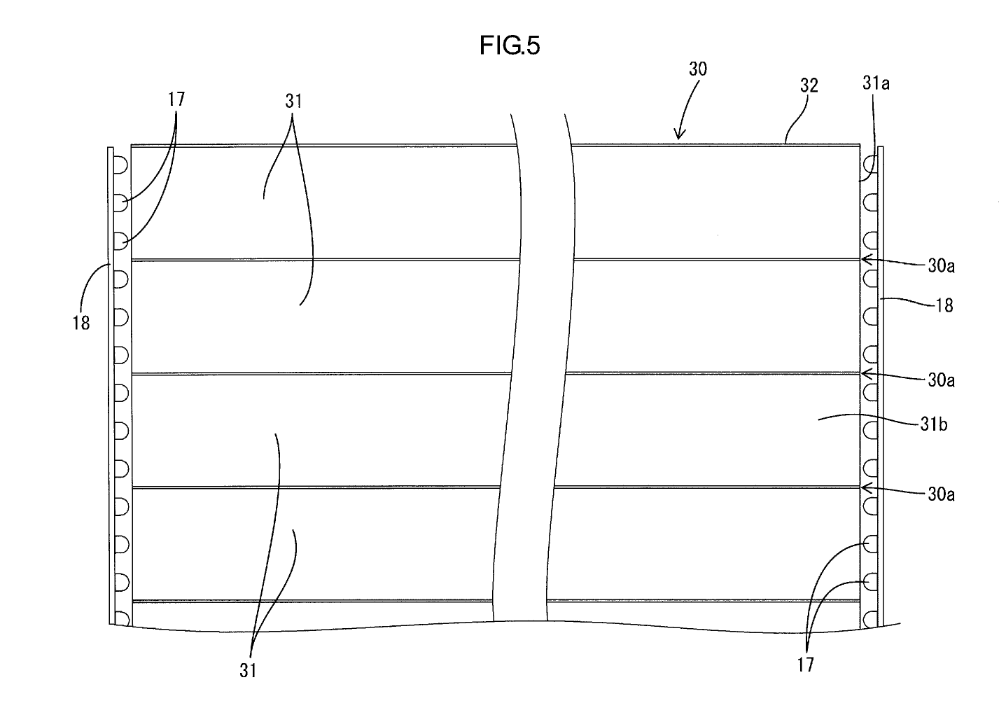

The first embodiment according to the present invention will be explained with reference to FIG. 1 to FIG. 5. In the present embodiment, a liquid crystal display device 10 will be described as an example. FIG. 1 is an exploded perspective view illustrating a general construction of a television receiver according to the present embodiment. FIG. 2 is an exploded perspective view illustrating a general construction of the liquid crystal device. FIG. 3 is a cross-sectional view illustrating a cross-sectional construction of the liquid crystal display device taken along the short-side direction. FIG. 4 is a cross-sectional view of the liquid crystal display device taken along the long-side direction. FIG. 5 is a plan view illustrating a planar arrangement of the LEDs and the light guide plates. An X-axis, a Y-axis and a Z-axis are described in a part of some drawings. Each of the axes corresponds to a common direction in each drawing. The upper side and the lower side in FIG. 2 correspond to the front side (the front-surface side, the light exit side) and the rear side (the rear-surface side, the side opposite to the light exit side), respectively.

As illustrated in FIG. 1, the television receiver TV of the present embodiment includes a liquid crystal display device 10 (display device), front and rear cabinets Ca, Cb which house the liquid crystal display device 10 therebetween, a power source P, a tuner T, and a stand S. The liquid crystal display device 10 has a landscape quadrangular shape (rectangular shape) as a whole. The liquid crystal display device 10 is housed in a vertical position. As illustrated in FIG. 2, the liquid crystal display device 10 includes a liquid crystal panel 11 as a display panel, and a backlight device 12 (lighting device) as an external light source. The liquid crystal panel 11 and the backlight device 12 are integrally held by a frame shaped bezel 13, for example.

As illustrated in FIG. 2, the liquid crystal panel 11 has a rectangular shape in a plan view. The liquid crystal panel 11 is configured such that a pair of glass substrates is bonded together with a predetermined gap therebetween and liquid crystal is sealed between the glass substrates. On one of the glass substrates, switching components (for example, TFTs) connected to source lines and gate lines which are perpendicular to each other, pixel electrodes connected to the switching components, and an alignment film and the like are provided. On the other substrate, color filters having color sections such as red (R), green (G) and blue (B) color sections arranged in a predetermined pattern, counter electrodes, and an alignment film and the like are provided. Polarizing plates are attached to outer surfaces of the substrates.

As illustrated in FIG. 2, the backlight device 12 includes a chassis 14, an optical sheet set 15 (a diffuser 15a and a plurality of optical sheets 15b which are provided between the diffuser 15a and the liquid crystal panel 11), and frames 16. The chassis 14 has a substantially box-like shape with an opening 14b on the light exit side (on the liquid crystal panel 11 side). The optical sheet set 15 is arranged so as to cover the opening 14b of the chassis 14. The frames 16 each provided along an outer edge portion of the chassis 14 holds an outer edge portion of the optical sheet set 15 such that the outer edge portion is sandwiched between the frame 16 and the chassis 14. Further, the chassis 14 houses LEDs 17 (Light Emitting Diode), LED boards 18 on which the LEDs 17 are mounted, a light guide plate 30 that guides the light emitted from the LEDs 17 to the optical member set 15 (the liquid crystal panel 11), a reflection sheet 19 (reflector) arranged on a rear surface of the light guide plate 30, and a pair of holders 21 on which edge portions of the optical member 15 and the liquid crystal panel 11 are placed. The backlight unit 12 is the edge-light type (side-light type) back light unit. Specifically, in the backlight unit 12, the LED boards 18 on which the LEDs 17 are arranged are provided at short-side end portions of the backlight unit 12 and the light guide plate 30 is provided between the LED boards 18. Hereinafter, each component of the backlight unit 12 will be explained.

The chassis 14 is made of metal such as aluminum. As illustrated in FIG. 3 and FIG. 4, the chassis 14 includes a bottom plate 14a having a rectangular shape like the liquid crystal panel 11, side plates 14b each of which rises from an outer edge of the corresponding side of the bottom plate 14a, and a pair of receiving plates 14c inwardly protruding from two of the side plates 14b that rise from short sides of the bottom plate 14a. An entire shape of the chassis 14 is a substantially shallow box shape with an opening on the front surface thereof. A long-side direction of the chassis 14 matches an X-axis direction (a horizontal direction) and a short-side direction thereof matches a Y-axis direction (a vertical direction). The frames 16 and the optical member 15, which will be described later, can be placed on the pair of receiving plates 14c of the chassis 14 from the front side. The frames 16 are fixed to the pair of receiving plates 14c with screws.

As illustrated in FIG. 2, the optical member 15 has a rectangular shape in a plan view like the liquid crystal panel 11 and the chassis 14. As illustrated in FIG. 3 and FIG. 4, outer edge portions of the optical member 15 are placed on the receiving plates 14c. The opening of the chassis 14 is covered with the optical member 15 and the optical member 15 is arranged between the liquid crystal panel 11 and the light guide plate 30. The optical member 15 includes a diffuser plate 15a provided on the rear side (the light guide member 30 side, a side opposite to the light exit side) and an optical sheet 15b provided on the front side (the liquid crystal panel 11 side, the light exit side). The diffuser plate 15a is formed by dispersing light diffusing particles in a substantially transparent resin base member having a predetermined thickness. The diffuser plate 15a diffuses the light transmitting therethrough. The optical sheet 15b has a sheet-like shape that is thinner than the diffuser plate 15a. The optical sheet 15b and the diffuser plate 15a are laminated on each other (see FIG. 2). Specific examples of the optical sheet 15b include a diffuser sheet, a lens sheet, and a reflection-type polarizing sheet, and any of them may be suitably selected to be used.

As illustrated in FIG. 2 and FIG. 3, the frames 16 each extend along the long-side direction of the chassis and are fixed to the short sides of the chassis 14. The frames 16 receive the rear surface of the long-side edge portion of the liquid crystal panel 11.

As illustrated in FIG. 2 and FIG. 3, the LED 17 is configured by sealing an LED chip with a resin material onto a base board that is fixed to the LED board 18. The LED chip that is mounted on the base board has one main light emission wavelength and specifically, the LED chip that emits a single color of blue is used. On the other hand, a fluorescent material is dispersed in the resin material that seals the LED chip therein. The fluorescent material converts blue light emitted from the LED chip into white light. This enables the LED 17 to emit white light. The LED 17 is a top-type LED that has a light emitting surface on a surface opposite to the mounting surface that is to be mounted to the LED board 18.

As illustrated in FIG. 2 and FIG. 3, each of the LED boards 18 has an elongated plate shape extending along the short-side direction (Y-axis direction) of the chassis 14. The main plate surface of the LED board 18 is arranged so as to be parallel to the Y-axis direction and the Z-axis direction. In other words, the LED board 18 is housed in the chassis 14 such that the main plate surface thereof is arranged to be perpendicular to the plate surfaces of the liquid crystal panel 11 and the optical member 15. The LED boards 18 are provided in a pair in the chassis 14. Each of the pair of LED boards 18 is arranged on short-side end portions of the chassis 14 and attached to the inner surface of the side plate 14b on the each short side of the chassis 14. The LED boards 18 are arranged so as to face the short-side surfaces of the light guide plate 30.

The LED 17 having the above configuration is mounted on a main plate surface of the LED board 18. The LEDs 17 are provided on the main plate surface of the LED board so as to be arranged linearly (in a straight line) along the long-side direction (Y-axis direction) thereof. Accordingly, the LEDs 17 are linearly arranged on the end portions of the backlight unit 12 along the short-side direction of the backlight unit 12. The pair of LED boards 18 are housed in the chassis 14 such that surfaces of the LED boards 18 on which the LEDs 17 are mounted face each other, and thus the emitting surfaces of the LEDs 17 mounted on the LED board 18 face each other. The light axis of each of the LEDs 17 substantially matches the X-axis direction.

The base member of the LED board 18 is made of metal such as aluminum like the chassis 14. Wiring pattern (not illustrated) made of a metal film such as a copper foil is formed on a surface of the LED board 18 with an insulating layer therebetween. The LEDs 17 arranged linearly on the LED board 18 are connected in series by the wiring pattern. The base member of the LED board 18 may be made of insulating material such as ceramic.

The reflection sheet 19 is made of synthetic resin (for example, foamed polyethylene terephthalate (PET)). A surface of the reflection sheet 19 has a white color that provides high light reflectivity. The reflection sheet 19 is arranged on a rear surface side of the light guide plate 30, which will be described later. Specifically, the reflection sheet 19 is arranged between the bottom plate 14a of the chassis 14 and the light guide plate 30 over substantially the entire area of the bottom plate 14a. The light exiting from the light guide plate 30 toward the rear side is reflected by the reflection sheet 19 so as to enter the light guide plate 30 again.

Next, the light guide plate 30 will be explained. The light guide plate 30 includes a plurality of light guide members 31 (here, eight light guide members) and a fixing member 32. The light guide members 31 correspond to the light guide bodies. In order to obtain the light guide plate 30, the light guide members 31 are linearly arranged and are collectively covered with the fixing member 32 by a molding process, for example. The light guide plate 30 is arranged right below the liquid crystal panel 11 and the optical member 15 in the chassis 14. The light guide plate 30 is sandwiched between the LED boards 18 that are arranged on the short-side end portions of the chassis 14.

The light guide member 31 is made of a substantially transparent (high light transmissive) synthetic resin material (such as acrylic) that has a higher refractive index than air. The light guide member 32 has a landscape rectangular shape in a plan view and also has a plate-like shape having a predetermined thickness. The main plate surfaces of the light guide members 31 are directed to the front side (the optical member 15 side) and are arranged parallel to the display surface of the liquid crystal panel 11. The light guide members 31 are arranged parallel to each other such that a long-side direction thereof matches the X-axis direction that is perpendicular to the arrangement direction of the LEDs 17 (the Y-axis direction). The light guide members 31 are aligned in the Y-axis direction.

Light emitted from the LEDs 17 in the X-axis direction enters the light guide members 31 and travels through the light guide member 31 to direct the light toward the optical member 15 (in the Z-axis direction). The short-side surfaces of the light guide members 31 that face the LEDs 17 serve as light entrance surfaces 31a through which the light from the LED 17 enters. The main plate surface of each of the light guide members 31 on the front side (the optical member 15 side) serves as the light exit surface 31b from which the light from the LED 17 exits.

The light guide members 31 are collectively formed by a molding process using the fixing member 32. The fixing member 32 is made of a synthetic resin such as acrylic that has refractive index substantially equal to that of air and lower than that of the light guide members 31, for example. The light guide members 31 are fixed in the chassis 14 by the fixing member 32 in fixed positions. The fixing member 32 continuously covers the light guide members 31 and the gaps 30a between the light guide members 31 without covering the light entrance surface 31a of each of the light guide members 31. A thickness of a portion of the fixing member 32 provided on the light exit surface 31b is equal to a thickness of a portion of the fixing member 32 provided on a surface of the collectively formed light guide members 31 that is close to the reflection sheet 19.

The construction of the present embodiment has been explained above and an operation thereof will be explained. The liquid crystal display device 10 is manufactured by assembling the liquid crystal panel 11, the backlight unit 12, and the bezel 13 that are separately manufactured. The light guide members 31 collectively formed by a molding process using the fixing member 32 can be treated as one light guide plate 30. The light guide plate 30 is fixed to a predetermined position after the reflection sheet 19 is arranged in the chassis 14. As described above, separated light guide members 31 can be collectively covered with the fixing member 32, so that the distance between the light guide members 31 and the corresponding LEDs 17 can be constant in advance. With this configuration, the light entrance efficiency of the light entering the light entrance surface 31a of the light guide members 31 from the corresponding LED 17 is kept to be constant, and therefore, the brightness difference between the light guide members 31 can be reduced.

When the manufactured liquid crystal display device 10 is turned on, a control circuit which is not illustrated controls driving of the liquid crystal panel 11 and driving of each LED 17 in the backlight unit 12, and thus, the liquid crystal panel 11 is illuminated with illumination light. Accordingly, images are displayed on the liquid crystal panel 11. Specifically, when LEDs 17 are lit individually, the light emitted from LEDs 17 enters the light entrance surfaces 31a of the respective light guide members 31. The light entered through the light entrance surface 31a is efficiently guided in the light guide member 31 by being reflected by the reflection sheet 19 and totally reflected at a boundary surface between the light guide member 31 and the fixing member 32, for example. Then, the guided light exits from the light exit surface 31b. The light exit surfaces 31b of the light guide members 31 provide a light exit surface of the backlight unit 12, and planar light exits therefrom.

According to the present invention, optical independence of each of the light guide members 31 is assured. Thus, depending on the image to be displayed, it can be independently determined whether or not to exit the light from each light exit surface 31b by controlling driving of each LED. For example, when the image to be displayed includes a black display area and non-black display area, the LEDs 17 corresponding to the light entrance surfaces 31a of the light guide members 31 that have the light exit surfaces 31b overlapping with the non-black display area in a plan view are lit so that the light exits from the light exit surfaces 31b. On the other hand, the LEDs 17 corresponding to the light entrance surfaces 31a of the light guide members 31 that have the light exit surfaces 31b overlapping with the black display area in a plan view are not lit so that the light does not exit from the light exit surfaces 31b. With this configuration, contrast of brightness and darkness between the black display area and the non-black display area can be increased, and thus high contrast performance can be obtained. By performing such a control (area-active control), not only excellent display quality, but also low power consumption can be achieved.

As described above, the backlight unit 12 according to the present embodiment includes the LEDs 17, the light guide members 31 each having the light entrance surface 31a and the light exit surface 31b, and the fixing member 32 collectively covering the light guide members 31. The light entrance surface 31a is arranged to face the LEDs 17 and the light from the LEDs 17 enters through the light entrance surface 31a. The light entered through the light entrance surface 31a exits from the light exit surface 31b. The fixing member 32 has a relative refractive index of one or less with respect to the light guide member 31.

With this configuration, the light guide members 31 are collectively covered with the fixing member 32, and this enables positional relationship of the light guide members 31 to be constant. Specifically, if the position of one of the light guide members 31 with respect to the LEDs 17 is determined, positions of other light guide members 31 are automatically determined. As a result, the positional relationship of the light guide members 31 with respect to the LEDs 17 can be constant, and thus the light entrance efficiency of the light emitted from the LEDs 17 to the light entrance surfaces 31a of the light guide members 31 can be constant. This can reduce the brightness difference between the light guide members 31.

In addition, an individual assembly operation for each light guide member 31 is eliminated, because the light guide members 31 can be treated as one component. As a result, an assembly operation of the light guide members can be facilitated.

The fixing member 32 is made of material having a smaller refractive index than the material of the light guide member 31. This prevents the light from exiting from the light guide member 31 through a surface other than the light exit surface 31b due to the total reflection. Accordingly, the light entered the light guide member 31 is prevented from entering the adjacent light guide member 31 through the fixing member 32. Thus, unevenness brightness due to the light entering through the surface other than the light entrance surface is less likely to occur.

The light exit surface 31b has a rectangular shape in a plan view. The light guide members 31 are arranged such that the light exit surfaces 31b of thereof are flush with each other and the long sides of the light exit surfaces 31b thereof are parallel to each other. The LEDs 17 are arranged to face the side surfaces of the light guide members 31 that extend along the short side of the light exit surfaces 31. The backlight unit 12 is an edge-light type backlight unit in which the LEDs 17 are arranged on the side surface of the light guide member 31. Thus, compared with a direct-type backlight unit, the backlight unit 12 can be thinner.

The refractive index of the fixing member 32 is substantially equal to that of air. Accordingly, the same conditions as in the case where the light guide member 31 is fixed without the fixing member 32 can be obtained. With this configuration, changes in the configuration of the backlight unit 12 around the light guide members 31 are not required, and thus, this technology can be readily applied to the conventional backlight unit 12.

The fixing member 32 has a portion provided on the light exit surfaces 31b of the light guide members 31 to cover the light exit surfaces 31b and the portion has a uniform thickness. If the portion of the fixing member 32 that covers the light exit surfaces 31b of the light guide members 31 has an uneven thickness, light transmission of the exited light may be varied. This causes uneven brightness. In order to prevent this, in the present embodiment, the portion of the fixing member 32 that covers the light exit surfaces 31b of the light guide members 31 has the uniform thickness.

The light entrance surface 31a of the light guide member 31 is not covered with the fixing member 32 and directly exposed to the LEDs 17. If the fixing member 32 that has light refractive index different from air is provided between the LEDs 17 and the light entrance surfaces 31a of the light guide members 31, the light that passed through the fixing member 32 travels in a different direction compared to the case where the fixing member 32 is not provided therebetween. In the present embodiment, the light entrance surfaces 31a of the light guide members 31 are not covered with the fixing member 32. Therefore, the fixing member 32 does not unnecessarily change the traveling direction of light and light entrance efficiency is not deteriorated.

The light guide members 31 and the fixing member 32 form one plate-like shape as a whole. With this configuration, the light guide plate 30 including the light guide members 31 and the fixing member 32 can be treated in the same manner as the conventional light guide member 31 that is formed of one plate, for example.

The reflection sheet 19 is provided on a side of the light guide members 31 that is opposite to the light exit surface 31b. The reflection sheet 19 reflects the light from the LEDs 17 toward the light exit surfaces 31b. With this configuration, the light traveling through the light guide plates 31 and reaches surfaces of the light guide plates 31 opposite to the light exit surface 31b is reflected by the reflection sheet 19. Thus, the light entering the light guide members 31 efficiently exits from the light exit surfaces 31b.

The light guide members 31 are collectively formed by a molding process using the fixing member 32. With this configuration, the light guide members 31 can be readily collectively covered. Further, compared with the process in which the light guide members 31 are connected using a plurality of fixing members 32, an installation error will not occur in the molding process in which the light guide members 31 are connected at one time. Thus, the positional relationship of the light guide members 31 can be kept stably constant.

The light sources are the LEDs 17. This achieves improved brightness, longer service life, and low power consumption, for example.

The LEDs 17 are mounted on the LED board 18 extending along the arrangement direction of the light guide member 31. With this configuration, the LEDs 17 can be easily arranged and the LEDs 17 can easily be wired.

In the above description, the first embodiment of the present invention is explained. The present invention is not limited to the above embodiment. The following modifications may be included in the technical scope of the present invention, for example. In the following modifications, similar parts to those in the above embodiment will be indicated by the same symbols and will not be illustrated or explained.

[First Modification of First Embodiment]

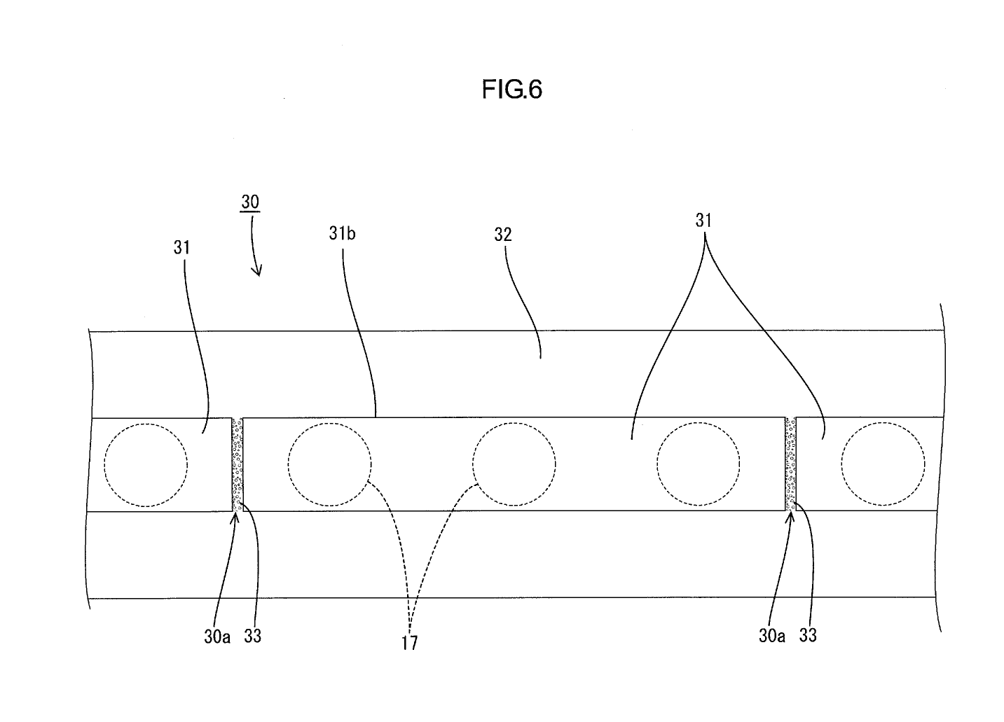

The first modification of the first embodiment will be explained with reference to FIG. 6. The first modification differs from the first embodiment in that sections of the fixing member 32 that are arranged in the gaps 30a between the light guide members 31 contain light diffusing particles 33. FIG. 6 illustrates a cross-sectional construction of a major part of the light guide plate 30 according to the first modification in a cross-sectional view taken along the short-side direction.

The light diffusing particles 33 such as silica and titanium oxide are substantially uniformly dispersed in the sections of the fixing member 32 that are arranged in the gaps 30a between the light guide members 31 of the light guide plate 30, as illustrated in FIG. 6.

With this configuration, the light exiting from the light guide members 31 to the gaps 30a between the light guide members 31 is refracted and diffused by the light diffusing material 33. Compared with the case where the fixing member 32 does not contain the light diffusing material, the light exiting from the light guide member 31 is less likely to enter the adjacent light guide member 31 via the gap 30a (some of the rays of light is diffused or reflected, and thus does not enter the adjacent light guide member 31). Accordingly, the light is less likely to enter a surface other than the light entrance surface 31a, and thus uneven brightness of the light exit surface 31b is less likely to occur.

Emission line may be visible in the gaps 30a between the light guide members 31 in some cases. In this modification, the light entering the gaps 30a can be diffused by the light diffusing material 33 provided in the gaps 30a between the light guide members 31. As a result, the emission line caused in the gaps 30a is less likely to be visible.

### Second Embodiment

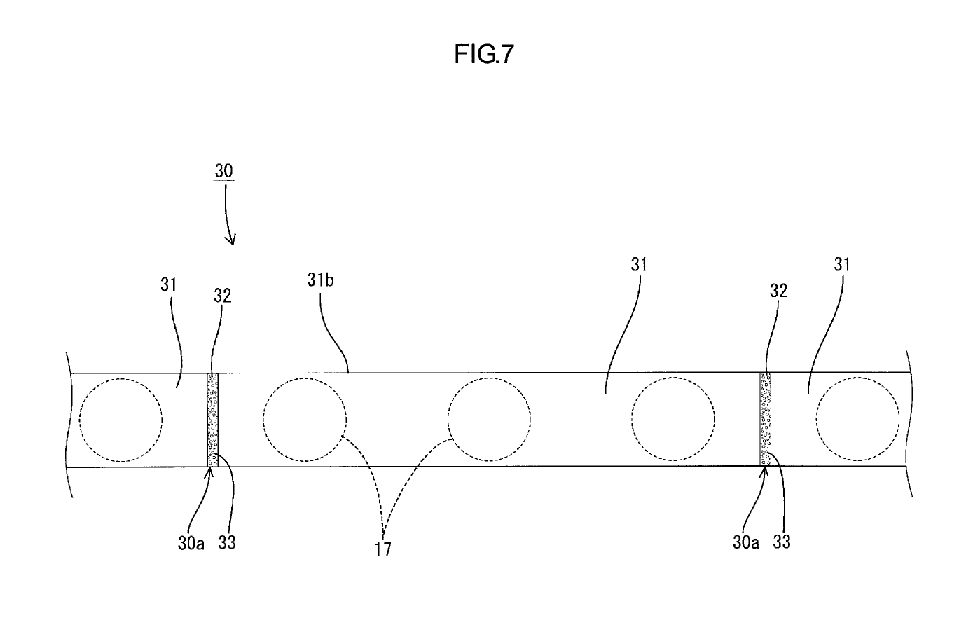

Next, the second embodiment of the present invention will be explained with reference to FIG. 7.

In the present embodiment, the fixing member 32 covers a different section of the light guide member 31 compared with the first embodiment. The other constructions same as those in the first embodiments described above will not be explained. FIG. 7 illustrates a cross-sectional construction of a major part of the light guide plate 30 in an enlarged cross-sectional view taken along the short-side direction.

As illustrated in FIG. 7, the fixing member 32 is only provided in the gaps 30a between the light guide members 31. The light guide members 31 are connected by the fixing members 32 provided in the gaps 30a. Like the first modification of the first embodiment, the light diffusing particles 33 are substantially uniformly dispersed in the fixing member 32.

With this configuration, the light guide members 31 are connected without the light exit surfaces 31b of the light guide members 31 being covered with the fixing member 32. If the light exit surfaces 31 of the light guide members 31 are covered with the fixing member 32, the light exiting from the light exit surfaces 31b passes through the fixing member 32 that has a refractive index different from that of air. Thus, the light exiting from the fixing member 32 is likely to travel in the direction different from the traveling direction of the light exiting from the light exit surfaces 31b. Accordingly, the light may enter a portion of the optical member 15 that corresponds to the light exit surface 31b of the adjacent light guide member, resulting in uneven brightness. In the present embodiment, not only the light entrance surfaces 31a but also the light exit surfaces 31b and the surfaces of the light guide members 31 close to the reflection sheet are exposed. With this configuration, the traveling direction of the light is less likely to be unnecessarily changed by the fixing member 32. This can prevent deterioration of the light exit efficiency and the uneven brightness.

### Third Embodiment

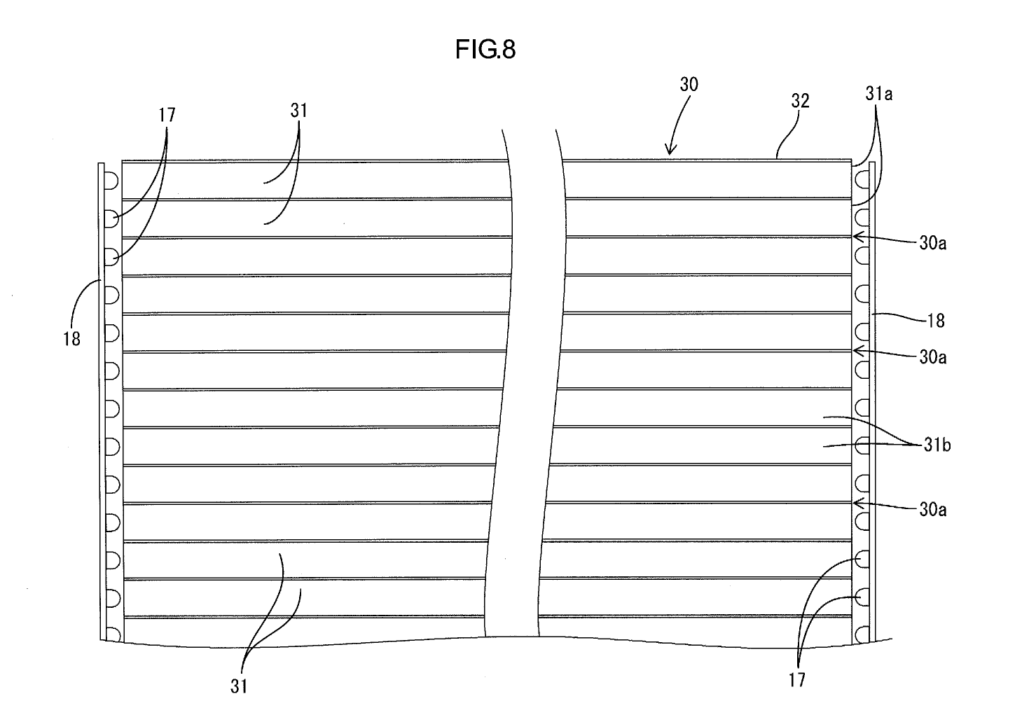

Next, the third embodiment of the present invention will be explained with reference to FIG. 8.

The present embodiment and the first embodiment are different in the number of the LED 17 facing one light guide member 31. The other constructions same as those in the first embodiments described above will not be explained. FIG. 8 illustrates a planar arrangement of the LEDs 17 and the light guide plate 30 in a partial plan view.

The light guide members 31 are sandwiched between the LED boards 18 provided on end portions of the chassis 14 along the short-side direction. Each of the short sides of the light guide member 31 of the third embodiment is shorter than that of the light guide member 31 in the first embodiment, and the short-side surfaces of the light guide members 31 serve as the light entrance surfaces 31a. The LEDs 17 are arranged such that one LED 17 corresponds to one light entrance surface 31a of each of the light guide members 31. The light guide members 31 are provided in the same number as the LEDs 17 that are linearly arranged in the Y-axis direction. The light guide members 31 are covered with the fixing member 32 to obtain the light guide plate 30.

In the light guide plate 30 having such a configuration, if the LEDs 17 are arranged on the end portions of the chassis 14 along the short-side direction, the light guide members 31 correspond to the respective LEDs 17, each of which is the smallest unit to be driven and controlled. Accordingly, it can be independently determined whether or not to exit the light from each light exit surface 31b of the light guide member 31 corresponding to every pair of the LEDs 17. As described above, whether or not to exit the light to the display screen can be more precisely controlled by subdividing the light guide members 31. This achieves improved display quality and low power consumption.

### Fourth Embodiment

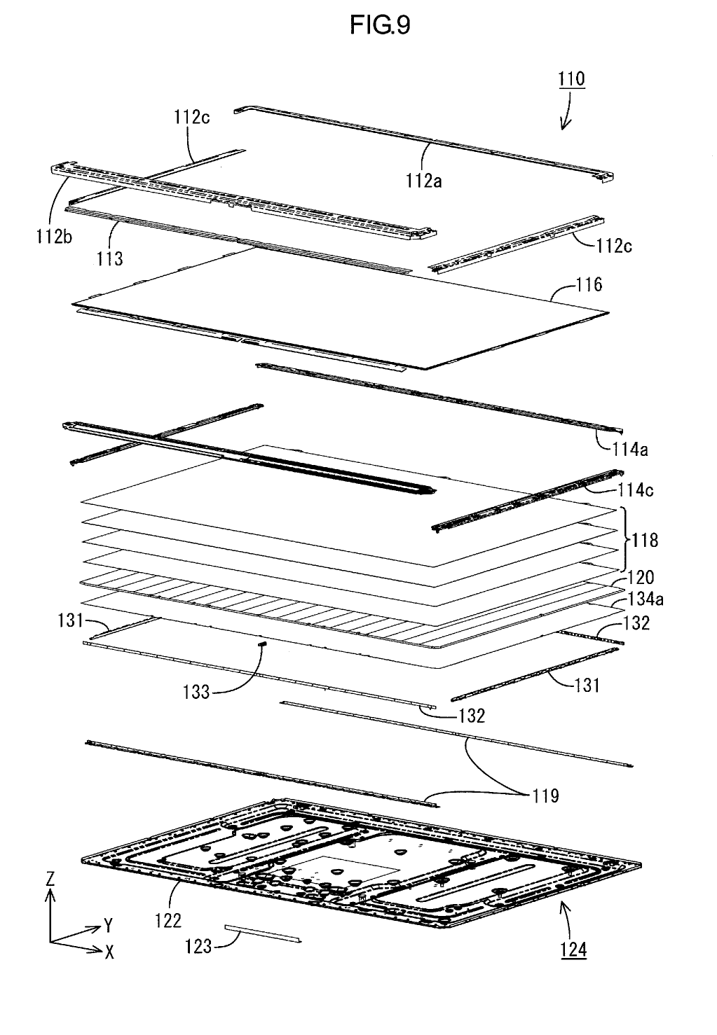

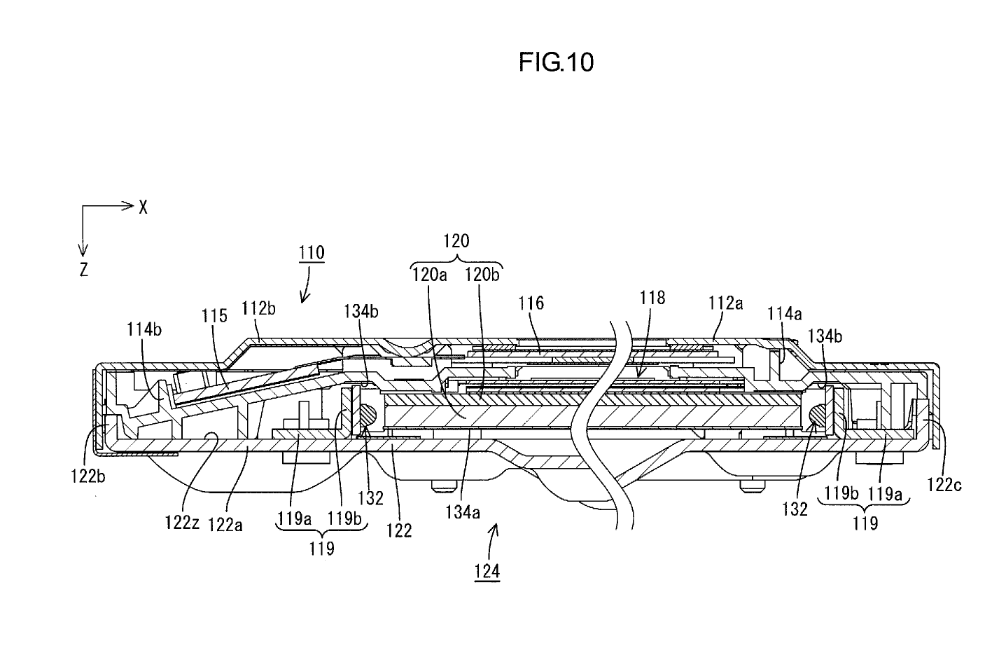

Next, the fourth embodiment of the present invention will be explained with reference to FIG. 9 and FIG. 10. FIG. 9 illustrates a liquid crystal display device 110 according to the present embodiment in an exploded perspective view. FIG. 10 illustrates a backlight unit 124 in a horizontal cross-sectional view. The upper side and the lower side in FIG. 9 correspond to the front side and the rear side, respectively. The constructions of a liquid crystal panel 116, an LED unit 143, alight guide plate 120, and an optical member 118 are substantially the same as those in the first embodiment, and will not be explained.

As illustrated in FIG. 9, the liquid crystal display device 110 has a landscape rectangular shape as a whole. The liquid crystal display device 110 includes the liquid crystal panel 116 as a display panel and the backlight unit 124 as an external light source. The liquid crystal panel 116 and the backlight unit 124 are integrally held by a top bezel 112a, a bottom bezel 112b, and a side bezel 112c (hereinafter, referred to as a bezel set 112a to 112c), for example.

The backlight unit 124 will be explained below. As illustrated in FIG. 9, the backlight unit 124 includes a backlight chassis 122, an optical member 118, a top frame 114a, a bottom frame 114b, a side frame 114c (hereinafter, referred to as a frame set 114a to 114c), and a reflection sheet 134a. The liquid crystal panel 116 is sandwiched between the bezel set 112a to 112c and the frame set 114a to 114c. The reference symbol 113 represents an insulating sheet that insulates a drive circuit board 115 (see FIG. 10) that drives the liquid crystal panel. The backlight chassis 122 has a substantially box-shape having a bottom with an opening on a front side (a light exit side, the liquid crystal panel 116 side). The reflection sheet 134a is provided on a rear side of the light guide plate 120. Further, the backlight chassis 122 houses a pair of cable holders 131, a pair of heat dissipation plates 119, a pair of LED units 132, and a light guide plate 120. The LED units 132, the light guide plate 120, and the reflection sheet 134a are supported each other by a rubber bush 133. On a rear surface of the backlight chassis 122, a power circuit board (not illustrated) that supplies power to the LED unit 132, a protective cover 123 configured to protect the power circuit board, and the like are provided. The pair of cable holders 131 extends along the short-side direction of the backlight chassis 122. The pair of cable holders 131 houses wires that electrically connect the LED unit 132 and the power circuit board.

As illustrated in FIG. 10, the backlight chassis 122 includes a bottom plate 122a having a bottom surface 122z and side plates 122b, 122c rising from an outer peripheral edge of the bottom plate 122a with a small height. The backlight chassis 122 at least supports the LED unit 132 and the light guide plate 120. The pair of heat dissipation plates 119 each includes a bottom plate 119a and a side plate 119b. The side plate 119b rises from one of outer edges on the long sides of the bottom plate 119a. The heat dissipation plate 119 has an L-shaped horizontal cross-sectional shape. The heat dissipation plates 119 each extend along the long-side direction of the backlight chassis 122. The bottom plate 119a of the heat dissipation plate 119 is fixed on the bottom plate 122a of the backlight chassis 122. The pair of LED units 132 extends along the long sides of the backlight chassis 122. The LED units 132 are each fixed to the side plate 119b of the heat dissipation plate 119 such that the light exit sides thereof face each other. The LED units 132 are each supported by the bottom plate 122a of the backlight chassis 122 via the heat dissipation plate 119. Heat generated at the LED unit 132 is dissipated outside the backlight unit 124 through the bottom plate 122a of the backlight chassis 122 by the heat dissipation plate 119.

As illustrated in FIG. 10, the light guide plate 120 is arranged between the pair of LED units 132, 132. The pair of LED units 132, the light guide plate 120, and the optical member 118 are sandwiched between the frame set 114a to 114c and the backlight chassis 122. The light guide plate 120 and the optical member 118 are held by the frame set 114a to 114c and the backlight chassis 122. Like the first embodiment, the light guide plate 120 includes the light guide members 120a linearly arranged along the arrangement direction of the LED units 132 and a fixing member 120b collectively covering the light guide members 120a.

A drive circuit board 115 is provided on a front surface of the bottom frame 114b. The drive circuit board 115 is electrically connected to the display panel 116 and image data and various control signals necessary to display the image are supplied to the liquid crystal panel 116 by the drive circuit board 115. Further, a first reflection sheet 134a is provided on a portion of a surface of the top frame 114a that is exposed to the LED unit 132. The first reflection sheet 134a extends along the long-side direction of the light guide plate 120. In addition, a second reflection sheet 134b is provided on a portion of a surface of the backlight chassis 122 that faces the LED unit 132. The second reflection sheet 134b extends along the long-side direction of the light guide plate 120.

### Other Embodiments

The present invention is not limited to the above embodiments described in the above description and the drawings. The following embodiments are also included in the technical scope of the present invention, for example.

(1) In the above embodiments, the LEDs 17 (the LED boards 18) are provided on the short-side end portions of the backlight unit 12. However, the LEDs 17 may be provided on the long-side end portions of the backlight unit 12. In such a case, the light guide members 31 are arranged along the arrangement direction of the LEDs 17 and covered with the fixing member 32. The LEDs 17 may be provided on only one end portion of the backlight unit 12.

(2) In the above first embodiment, the light guide members 31 are collectively formed by a molding process using the fixing member to obtain the light guide plate 30. However, each of the light guide members 31 may be bonded or inserted to the fixing member 32 to obtain the light guide plate 30, for example. With this configuration, the fixing member 32 is not necessarily provided in the gaps 30a between the light guide members 31. Thus, the uneven brightness caused by the fixing member 32 provided between the gaps 30a is less likely to occur.

(3) In the above embodiments, the light guide members 31 are covered or connected by the fixing member 32, so that the light guide members 31 can be treated as one plate-shaped light guide plate 30. However, the light guide members 31 may be formed to configure two light guide plates 30. In such a case, one of the light guide plates 30 includes at least two or more light guide members 31. With this configuration, in an assembly operation of the backlight unit 12 that is used for a large screen display, the light guide plate 30 divided into two or more can be set in the backlight unit 12. This facilitates the assembly operation.

(4) In the above embodiments, the light guide members 31 are the same in size, but the light guide members 31 may have different sizes. For example, an area of each of the light exit surfaces 31b of the light guide members 31 that are located at the middle area of the chassis 14 may be smaller than that of the light exit surfaces 31b of the light guide members 31 that are located at the end portions of the chassis 14. The middle area of the chassis 14 corresponds to the middle section of the display screen. This configuration improves contrast performance of the middle section of the screen which is easily viewable area and achieves the reduction in the cost.

(5) In the above embodiment, the light guide members 31 each have a flat plate shape, but the light guide members 31 may have triangular prism or cylindrical shape, for example.

(6) In the above embodiments, the LED 17 including the LED chip that emits a single color of blue is used. However, an LED including an LED chip that emits a single color of purple may be used. Moreover, an LED including three different kinds of LED chips each emit a single color of R, G, and B may be used.

(7) In the above embodiments, the LEDs 17 mounted on the LED board 18 is used. However, LEDs arranged on a film board may be used.

(8) In the above embodiments, TFTs are used as switching components of the liquid crystal display device 10. However, the technology described above can be applied to liquid crystal display devices including switching components other than TFTs (e.g., thin film diode (TFD)). Moreover, the technology can be applied to not only color liquid crystal display devices but also black-and-white liquid crystal display devices.

(9) In the above embodiments, the liquid crystal display device 10 including the liquid crystal panel 11 as a display panel. The technology can be applied to display devices including other types of display components.

(10) In the above embodiments, the television receiver 10 including the tuner T is used. However, the technology can be applied to a display device without the tuner.

### EXPLANATION OF SYMBOLS

10: liquid crystal display device (display device), 11: liquid crystal panel (display panel), 12: backlight unit (lighting device), 14: chassis, 15: optical member, 17: LED (light source), 18: LED board, 19: reflection sheet (reflector), 30: light guide plate, 31: light guide member (light guide body), 31a: light entrance surface, 31b: light exit surface, 32: fixing member, 33: light diffusing particles, TV: television receiver

1. A lighting device comprising:
a plurality of light sources;
a plurality of light guide bodies each having a light entrance surface and a light exit surface, the light entrance surface facing at least one of the light sources and through which light emitted from the light source enters, the light exit surface through which the light in the light guide body exits; and
a fixing member provided so as to connect the light guide bodies, the fixing member having a relative refractive index of one or less with respect to the light guide body.

2. The lighting device according to claim 1, wherein:
the light exit surface has a plan view rectangular shape having a long side and a short side;
the light guide bodies are arranged such that the light exit surfaces thereof are in flush with each other and the long side of each light exit surface is parallel to each other; and
the light sources are arranged so as to face side surfaces of the light guide bodies that extend along the short side of the light exit surface and the side surfaces are the light entrance surfaces.

3. The lighting device according to claim 1, wherein the fixing member has a refractive index substantially equal to a refractive index of air.

4. The lighting device according to claim 1, wherein:
the fixing member is provided between the adjacent light guide bodies; and
the fixing member contains a light diffusing material.

5. The lighting device according to claim 16, wherein the fixing member is provided to cover the light exit surfaces of the light guide bodies and the fixing member provided on the light exit surfaces has a uniform thickness.

6. The lighting device according to claim 16, wherein the light entrance surfaces of the light guide bodies are not covered with the fixing member and directly exposed to the light sources.

7. The lighting device according to claim 1, wherein the light guide bodies and the fixing member form one plate-like shape as a whole.

8. The lighting device according to claim 1, further comprising a reflector configured to reflect the light from the light sources, the reflector being arranged on a side of the light guide body that is opposite to the light exit surface.

9. The lighting device according to claim 1, wherein the light guide bodies are collectively formed by a molding process using the fixing member.

10. The lighting device according to claim 1, wherein the light sources are LEDs.

11. The lighting device according to claim 10, further comprising an LED board on which the LEDs are mounted, the LED board extending along an arrangement direction in which the light guide bodies are arranged.

12. The lighting device according to claim 1, wherein each one of the light sources is arranged so as to correspond to each one of the light entrance surfaces of the light guide bodies.

13. A display device comprising:
the lighting device according to claim 1; and
a display panel configured to provide display using light from the lighting device.

14. The display device according to claim 13, wherein the display panel is a liquid crystal display including a pair of substrates with liquid crystals sealed therebetween.

15. A television receiver comprising the display device according to claim 13.

16. The lighting device according to claim 1, wherein the fixing member is provided so as to collectively cover the light guide bodies.

17. The lighting device according to claim 16, wherein the fixing member contains a light diffusing material in a section provided in a gap between the adjacent light guide bodies.
